(19) United States
(12) Patent Application Publication
(10) Pub. No.: US 2012/0099997 A1
(43) Pub. Date: Apr. 26, 2012

(54) Vertical Axis Wind Turbine

(75) Inventors: Hanjun Song, Beijing (CN); Yun Liu, New York, NY (US); Nicolas Blitterswyk, New York, NY (US)

(73) Assignee: URBAN GREEN ENERGY, INC., New York, NY (US)

(21) Appl. No.: 13/380,793

(22) PCT Filed: Jun. 24, 2010
(86) PCT No.: PCT/IB10/01524

§ 371 Date: Dec. 23, 2011

(30) Foreign Application Priority Data
Jun. 26, 2009 (CN) 200920160538.3

(51) Int. Cl. F03D 3/06

(52) U.S. Cl. 416/210 R

(57) ABSTRACT

A vertical axis wind turbine comprising a main wind blade with one or more blade(s), at least one connecting arm, attached to main blade and an abutment of connecting arm arranged with axle hole of wind rotor shaft, wherein, a main blade is fixed with abutment of connecting arm through connecting arm to form an vertical axis wind turbine.

### TECHNICAL FIELD

The present invention relates to a vertical axis wind turbine (VAWT), comprising a main wind blade with one or more blade(s), a connecting arm attached to the main wind blade and an abutment of the connecting arm arranged with the axle hole of a wind rotor shaft at the middle, wherein the main wind blade is fixed with the attachment piece of the connecting arm to form the VAWT. The section of the connecting arm may or may not form an airfoil.

### BACKGROUND ART

At present, vertical axis wind rotors have the capability to compete with horizontal axis three-blade wind rotors on efficiency. VAWTs have an advantage over horizontal-axis wind turbines in that they do not need to be oriented into the prevailing wind direction. VAWTs are able to produce a rotational movement irrespective of the wind direction. However, this kind of wind rotor is hard to be started up without outside force. This brings difficulty to the prevalence of this type of wind turbine generator.

The blades can be subject to very high stresses due to the centrifugal forces produced on rotation of the turbine at high rotational speeds. The noise levels can reach unacceptable grades. These are produced by large vortices shed at the blade tips, due to centrifugal forces produced on rotation of the turbine, at high rotational speeds. As the blades alternate between crossing the wind direction and coasting, uneven torque may be produced from the lifting surfaces of the VAWTs.

One way of improving the VAWT is to provide connecting arms which may have an improved aerodynamic structure.

WO2008141763 discloses a supporting arm for the blades of wind turbines with a vertical rotational axis, said arm being situated substantially along a radius between the hub or the bearing organ of the turbine and each of the blades that lie at a corresponding distance from said hub. The cross-section of the arm is substantially symmetrical about a horizontal axis and is formed by a front convex surface and a rear concave surface according to the rotational direction of the rotor. Said cross-section, whether it is the concave or the convex surface, takes the form of an arc, a parabola, a nose cone or a leading edge of a blade profile.

WO2010001141 discloses a VAWT comprising at least three blades each attached to a central hub via support struts angled at between 55° to 85° to each other.

### DEFINITIONS

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

It must be noted that as used herein and in the appended claims, the singular forms “a,” “and” and “the” include plural references unless the context clearly dictates otherwise.

### SUMMARY OF THE INVENTION

Provided herein is a VAWT with advantages of convenient start up of the wind rotor and high utilization ratio of wind power.

The present invention relates to a VAWT, comprising the main wind blade with optionally, two or more blades, the connecting arm which is attached to the main wind blade and the abutment of the connecting arm. The connecting arm shall be arranged with the axle hole of the wind rotor shaft at the middle, wherein, the mentioned main wind blade shall be fixed with the abutment of the connecting arm, by the connecting arm, to form the VAWT. The section of the mentioned connecting arm may be in the form of an airfoil. With adoption of the above-mentioned structure, the connecting arm is not only one part of the wind turbine, but is also a component to support the main wind blade and generate power in the wind turbine. This enhances the utilization ratio of the wind power and the wind turbine material, and reduces the outline dimension of the wind turbine to make the structure of the wind turbine simpler.

The present invention relates to a connecting arm, which is characterized in one or more of the section(s) of the mentioned connecting arm may be in the form of an airfoil. The connecting arm may have an airfoil chord length of about between 0.5 cm and about 200 cm. Preferably the connecting arm may have an airfoil chord length of about between 15 cm and about 70 cm. More preferably the connecting arm may have an airfoil chord length of about between 20 cm and about 67 cm. The connecting arm may form an airfoil with at least two different airfoil thicknesses. The connecting arm airfoil thickness may be a maximum of 30% of the chord length and a minimum of 0.1% of the chord length. The connecting arm may have an opposing airfoil design. This structure can act to counter centrifugal forces that pull the blade(s) outward, and cause the connecting arms to be pulled together.

In an alternative embodiment of the present invention, the connecting arm is characterized in one or more of the section(s) of the mentioned connecting arm may be substantially flat. In an alternative embodiment of the present invention, the connecting arm is characterized in one or more of the section(s) of the mentioned connecting arm may be flat.

In an alternative embodiment of the present invention, the connecting arm is characterized in one or more of the section(s) of the connecting arm may form a concave shape next to the abutment of the connecting arm, an airfoil in the central area of the connecting arm and a concave shape next to the attachment piece, thus, creating a wave effect.

Preferably in an alternative embodiment of the present invention, the connecting arm may form a concave shape, on the trailing edge, next to the abutment of the connecting arm, an airfoil in the central area of the connecting arm and a concave shape next to the attachment piece, thus, creating a wave effect on the trailing edge of the connecting arm.

The mentioned connecting arm and abutment of the connecting arm may be divided into two or more groups, upper, lower and midsection(s). Through the two or more groups of connecting arms upper, lower and midsection(s), the mentioned main wind blade shall be fixed with two or more abutments of connecting arms upper, lower and/or midsection(s), as per pre-set angle.

The mentioned connecting arm and abutment of connecting arm may be oriented at an angle between 1° and 179° with respect to the drive shaft barrel. Preferably the mentioned upper and/or midsection(s) connecting arm(s) may be oriented at an upper angle of between about 1° and about 90° and a lower angle of about 90° and 179° with respect to the drive shaft barrel. More preferably the mentioned upper and/or midsection(s) connecting arm may be oriented at an upper angle of about between 45° to 70° and a lower angle of about between 100° to 140° with respect to the drive shaft barrel.

Preferably the mentioned lower and/or midsection(s) connecting arm may be oriented at an upper angle of about 90° and 179° and a lower angle of between about 1° and about 90° with respect to the drive shaft barrel. Preferably the mentioned lower and/or midsection(s) connecting arm may be oriented at an upper angle of about between 100° to 140° and a lower angle of about between 45° to 70°, with respect to the drive shaft barrel. The mentioned midsection(s) connecting arm may be oriented at an upper angle of 90° with respect to the drive shaft barrel.

The mentioned abutment of connecting arms and connecting arms may comprise one or more separate connecting arm(s). The mentioned abutment of connecting arms and connecting arms may comprise two or more connecting arm(s) which form a single piece. Preferably the mentioned abutment of connecting arms and connecting arms may comprise three separate abutments of connecting arms and connecting arms.

The lower set of connecting arm(s) may be attached to the main wind blade and lower flange of the wind generator, and the axle hole of the wind rotor shaft is arranged at the middle shaft of the mentioned connecting arm(s), wherein, the mentioned main wind blade is fixed with the lower flange of the wind generator of connecting arm through the connecting arm to form the VAWT.

The upper set of connecting arm(s) may be attached to the main wind blade and upper flange of the wind generator, and the axle hole of the wind rotor shaft is arranged at the middle shaft of the mentioned connecting arm(s), wherein, the mentioned main wind blade is fixed with the upper flange of the wind generator of connecting arm through the connecting arm to form the VAWT.

The mid section set of connecting arm(s) may be attached to the main wind blade and midsection(s) flange of the wind generator, and the axle hole of the wind rotor shaft is arranged at the middle shaft of the mentioned connecting arm(s), wherein, the mentioned main wind blade is fixed with the midsection(s) flange of the wind generator of connecting arm through the connecting arm to form the VAWT.

The connecting arm(s) may be between about 100 mm and about 10,000 mm or more in length. Preferably the connecting arm(s) may be between about 500 mm and about 5000 mm in length. More preferably the connecting arm(s) may be between about 800 mm and about 1600 mm in length.

The connecting arm to turbine generator attachments may be, but are not limited to bolts, nuts, screws and nails. Preferably the connecting arm to turbine generator attachments comprise bolts. The connecting arm to turbine generator attachments may comprise one or more bolt(s). Preferably the connecting arm to turbine generator attachments comprise five bolts.

The connecting arm attachment to the wind blade may be an open or closed hoop. The connecting arm attachment to the wind blade may be a split hoop forming two separate pieces. The connecting arm attachment to the wind blade may be a filling piece. The connecting arm attachment to the wind blade may be an open or closed hoop comprising one or more holes for securing the connecting arm to the blade. Preferably the connecting arm attachment to the wind blade may be an open or closed hoop comprising two holes for securing the connecting arm to the blade. The blades may be fixed inside the hoop with bolts. The hoop may be attached to the blade using other means known in the art. The connecting arm attachment to the wind blade may be an attachment piece. The attachment piece may be attached to the blade using bolts or screws. The attachment piece may be attached to the blade using other means known in the art.

In an alternative embodiment, the attachment piece may be attached to the connecting arm using a hub connecting board, comprising an attachment piece hub connecting segment and a connecting arm wedge-shaped dovetail groove segment.

The midsection(s) and/or upper connecting arm(s) may be attached to the main wind blade and drive shaft barrel of the turbine and the axle hole of wind rotor shaft is arranged at the middle of the mentioned connecting arm, wherein, the mentioned main wind blade is fixed with the shaft through the connecting arm to form the VAWT. The mid and upper connecting arm(s) may be attached to the main wind blade and drive shaft barrel of the turbine, via an upper flange, said flange attached to the drive shaft barrel, and the axle hole of the wind rotor shaft, which is arranged at the middle of the mentioned connecting arm, wherein, the mentioned main wind blade is fixed with the shaft of the connecting arm through the connecting arm to form the VAWT.

The mentioned connecting arm(s) shall be divided preferentially into two groups upper and lower, and the mentioned main wind blade shall be fixed with the shaft of the upper connecting arm(s) through the upper connecting arms as per pre-set angle.

The mentioned connecting arm(s) shall be divided preferentially into two groups upper and lower, and the mentioned main wind blade shall be fixed with external rotor generator of the lower connecting arm(s) through the lower connecting arm(s) as per pre-set angle.

The connecting arms may comprise materials which include but are not limited to, a mixture or any one of the following; fibre glass or carbon fiber with epoxide resin, high strength glass, plastic, foam and/or metal.

The connecting arms for the 1 kW and 4 kW model may comprise metal. Preferably the connecting arms for the 600w model may comprise metal. The connecting arm for the 1 kW and 4 kW model may comprise a metal section located at the connecting piece end of the connecting arm and extending into the length of the connecting arm.

The connecting arm may comprise a metal attachment piece extending into the length of the connecting arm and the length of the connecting arm comprising a mixture or any one of the following fibre glass or carbon fiber with epoxide resin, high strength glass, foam, plastic and/or metal.

The connecting arm group(s) may be set at an off set angle to each other or set directly inline with each other.

In an alternative embodiment the connecting arm(s) may have secure material inside the length of the connecting arm. The secure material may or may not be attached to the inside of the connecting arm. The secure material may extrude outside of the connecting arm. Alternatively, the secure material may be accessible from the outside of the connecting arm. At a point where the connecting arm attaches to the blade, the secure material may form a loop. Said loop may extrude from the connecting arm through an attachment piece or said loop may be located inside the connecting arm accessible from the outside. Said blade loop may be formed from secure material extending either the length of the blade or no more than the length of the blade. The secure material loop of the blade either being accessible from the point of blade and connecting arm attachment or extruding from the blade at the point of connecting arm and blade attachment. The loop from the blade and the loop from the connecting arm may be securely attachable to each other. Alternatively, the secure material may extend in a loop through a lower connecting arm through the generator shaft, through the upper connecting arm and through the blade so as to form a closed loop. Examples of secure material include but are not limited to either one or more of rope, chain, metal, wire, string, nylon, rubber, coiled spring and/or plastic.

With adoption of the above-mentioned structure, the connecting arm is not only one part of wind turbine, but also the component to support the main wind blade and generate power within the wind turbine, which enhance the utilization ratio of power and material of the wind turbine, and reduce the outline dimension of the wind turbine to make the wind turbine structure simpler.

With the implication of an alternative embodiment the above mentioned VAWT provides a safety feature to ensure the blades do not become fully separated from the other parts of the VAWT.

### BRIEF DESCRIPTION OF DRAWINGS

FIG. 1 is a schematic illustration, from a top down perspective, of a group of upper and a group of lower connecting arms.

FIG. 2 is a schematic illustration, of the vertical axis wind turbine of the present invention.

FIG. 3 is a schematic illustration, from a top perspective, of a lower (or midsection(s)) connecting arm with an open hoop attachment.

FIG. 4 is a schematic illustration, from a top perspective, of a lower (or midsection(s)) connecting arm with an open hoop attachment.

FIG. 5 is a schematic illustration, from a top perspective, of an upper (or midsection(s)) connecting arm with an open hoop attachment.

FIG. 6 is a schematic illustration, from a top perspective, of an upper (or midsection(s)) connecting arm with an open hoop attachment.

FIG. 7 is a schematic illustration, from a side perspective, of a lower (or midsection(s)) connecting arm with an open hoop attachment.

FIG. 8 is a schematic illustration, from a face on perspective, of a lower (or midsection(s)) connecting arm with an open hoop attachment.

FIG. 9A is a schematic illustration, from a top perspective, of an upper (or midsection(s)) connecting arm with no attachment. FIG. 9B is a schematic illustration, from a top perspective, of a lower (or midsection(s)) connecting arm with no attachment.

FIG. 10 is a schematic illustration, from a top perspective, of a lower (or midsection(s)) connecting arm with an attachment piece.

FIG. 11 is a schematic illustration, from a top perspective, of an upper (or midsection(s)) connecting arm with an attachment piece.

### DETAILED DESCRIPTION OF SPECIFIC EMBODIMENTS

Hereunder the present invention shall be given further description with incorporation of the attached figures and examples.

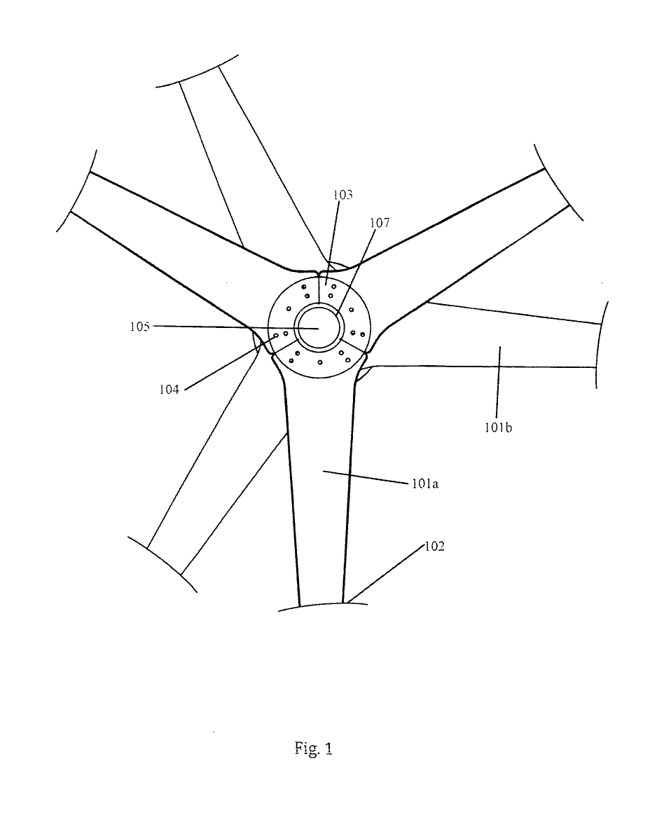

According to FIG. 1 the upper connecting arms 101a shall be set at an off set angle to the lower connecting arms 101b, the connecting arms 101a, 101b shall be attached via the abutment of the connecting arm 103 and secured through the use of a means of attachment 104. The connecting arms shall be arranged with the axle hole 105 and wind rotor shaft 107 at the middle.

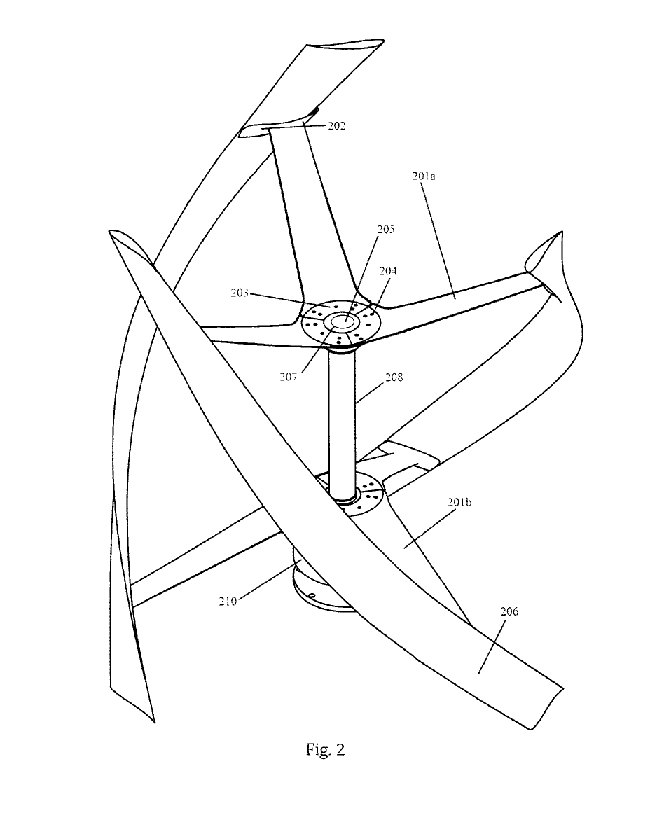

According to FIG. 2, the main wind blade 206 shall be connected with the drive shaft barrel 208 via the connecting arm 201a, 201b, and multiple connecting arm(s) 201a, 201b shall be connected together via the abutment of connecting arm 203. The abutment of the connecting arm 203 and the mentioned connecting arm 201a, 201b, shall be arranged around the axle hole 205 of the wind rotor shaft 207, and the bearing shall be arranged at the interior of the mentioned axle hole 205, so that the connecting arm can be arranged on the drive shaft barrel 206. The mentioned main wind blade 206 shall be fixed with the attachment piece 202 of connecting arm 201a, 201b to form the VAWT.

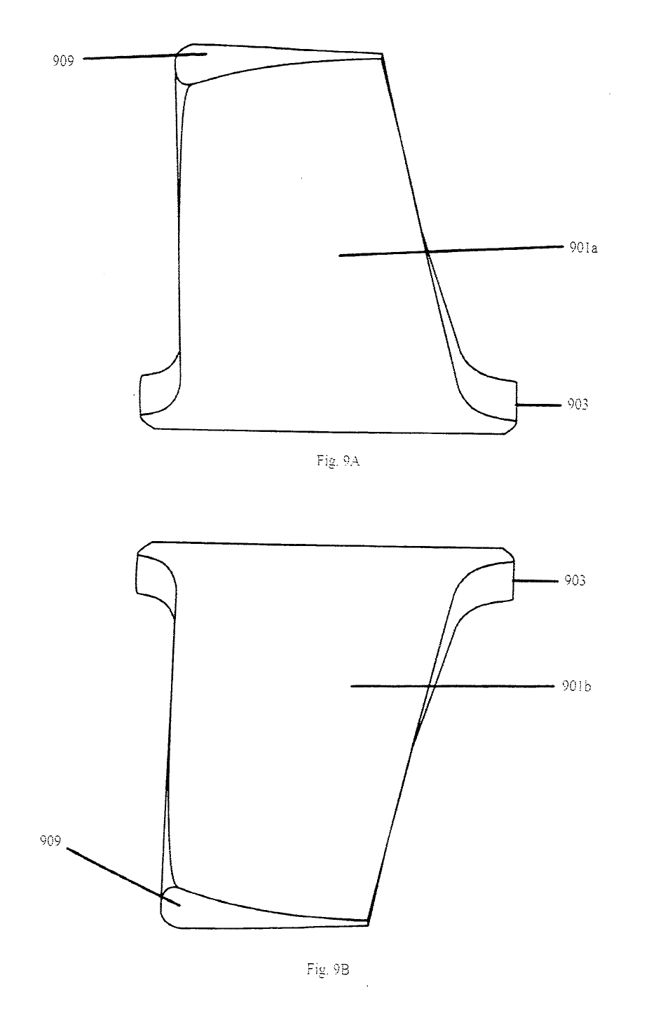

According to FIG. 9A, FIG. 9B and FIG. 2, the connecting arm 201a, 901a, 201b, 901b is in the form of an airfoil 909, and the mentioned airfoil 909 is not only the various airfoil sections in the various design options of the wind blade in the field of wind turbine generator, but also the airfoil sections of special design, which shall be selected or designed in regard to shape as per various factors such as quantity of the connecting arm and the angle between connecting arm 201a, 901a, 201b, 901b, and drive shaft barrel 208 or wind rotor shaft 207.

With adoption of the airfoil connecting arm, the connecting arm is not only one part of the wind turbine, but also a component to support the main wind blade and generate power in the wind turbine, which enhances the utilization ratio of wind power and material of the wind turbine, and decreases the outline dimension of the wind turbine. Furthermore, this feature makes the structure of wind turbine simpler. In addition, the airfoil connecting arm makes the wind turbine quieter. This reduction in noise is achieved through the airfoil providing a smooth movement through the air.

According to FIG. 2, the above-mentioned attachment piece 202 of the wind blade 206, connecting arm 201a, 201b, axle hole 205 and abutment of connecting arm 203 shall make a whole with material of main part compounded by high strength glass fiber or carbon fiber with epoxide resin. The main wind blade 206 shall be positioned at the attachment piece 202 of the connecting arm 201a, 201b and be fixed by the attachment means 204. The connecting arm 201a, 201b and the main wind blade 206 may be joined via one-step moulding set at a given angle of the wind blade. The drive shaft barrel 208 may drive the generator 210 to generate power through the wind rotor shaft 207 when wind is passing through the wind turbine generator.

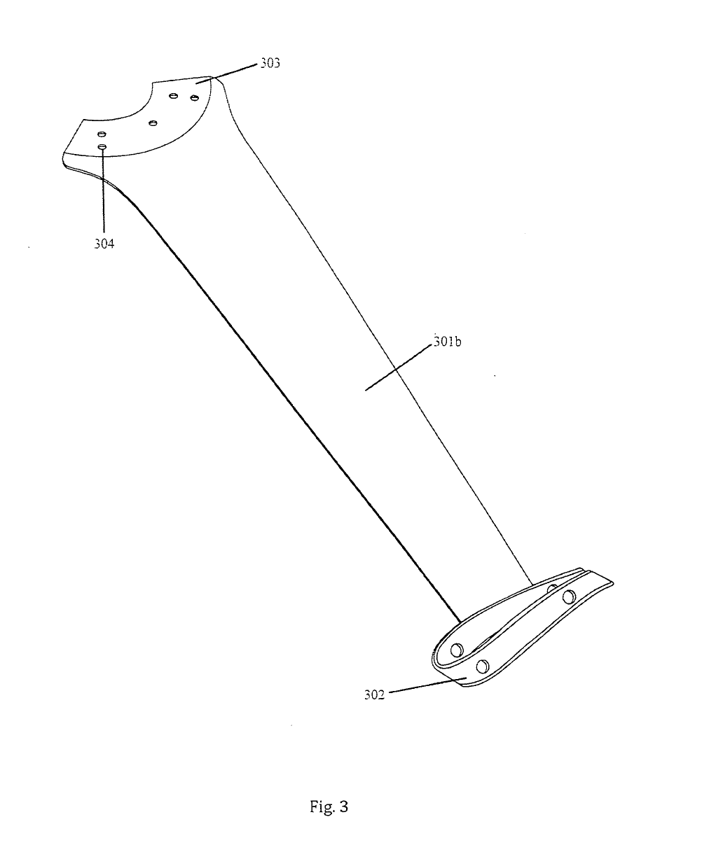

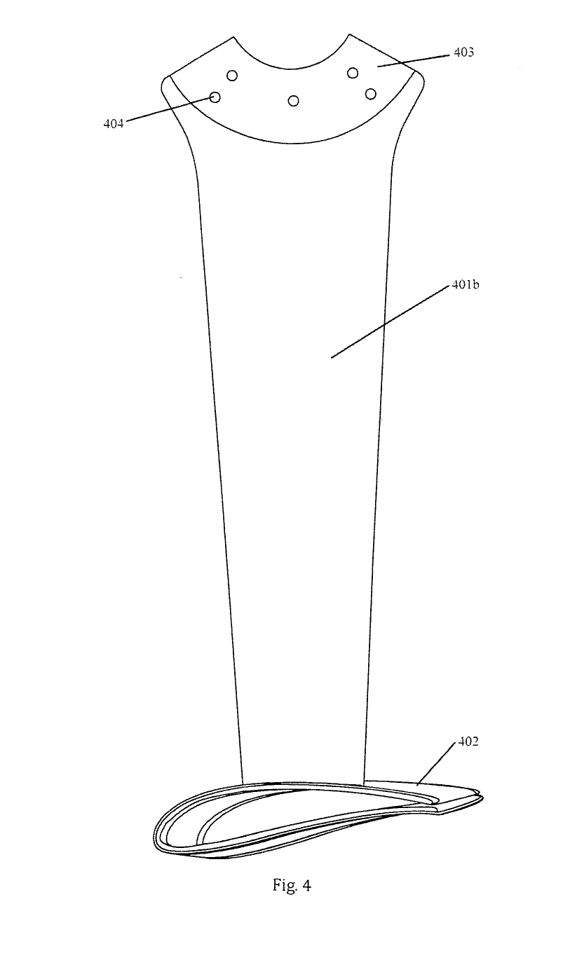

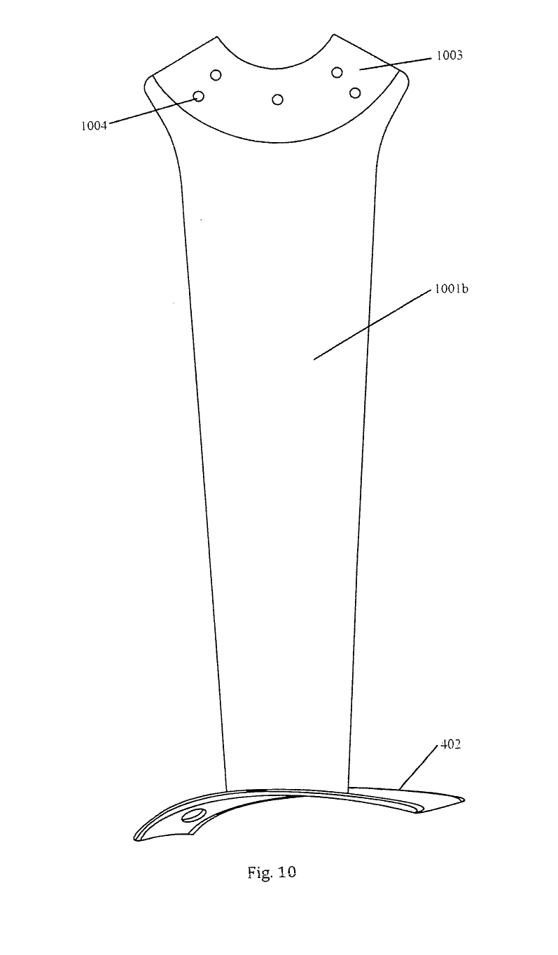

According to FIGS. 3, 4 and 10, the lower or midsection(s) connecting arm(s) 301b, 401b, 1001b shall comprise an attachment piece 302, 402, 1002 the attachment piece 302, 402, 1002 may also comprise other arrangements not shown. The abutment of the connecting arm 303, 403, 1003 may comprise five attachment means 304, 404, 1004.

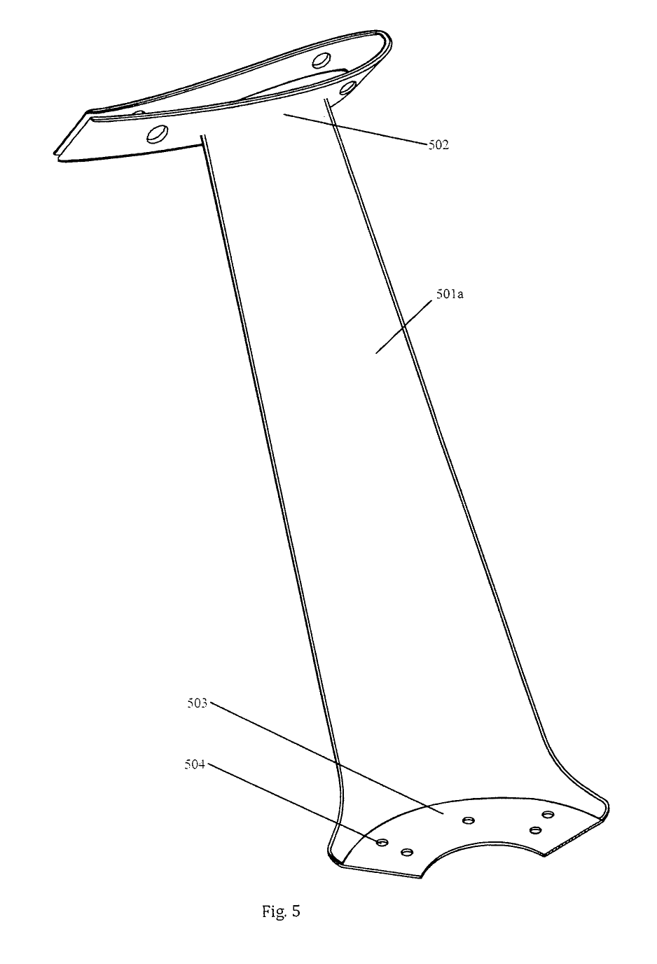

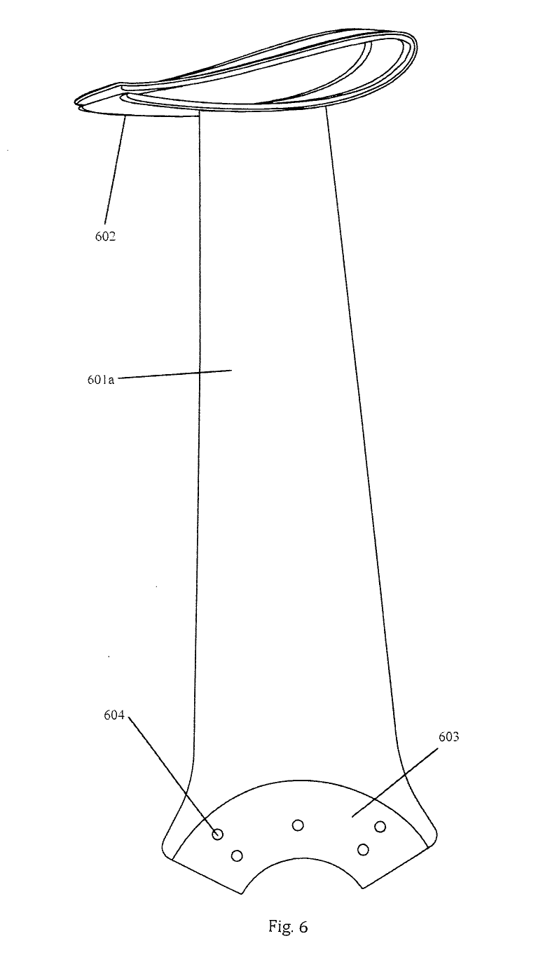

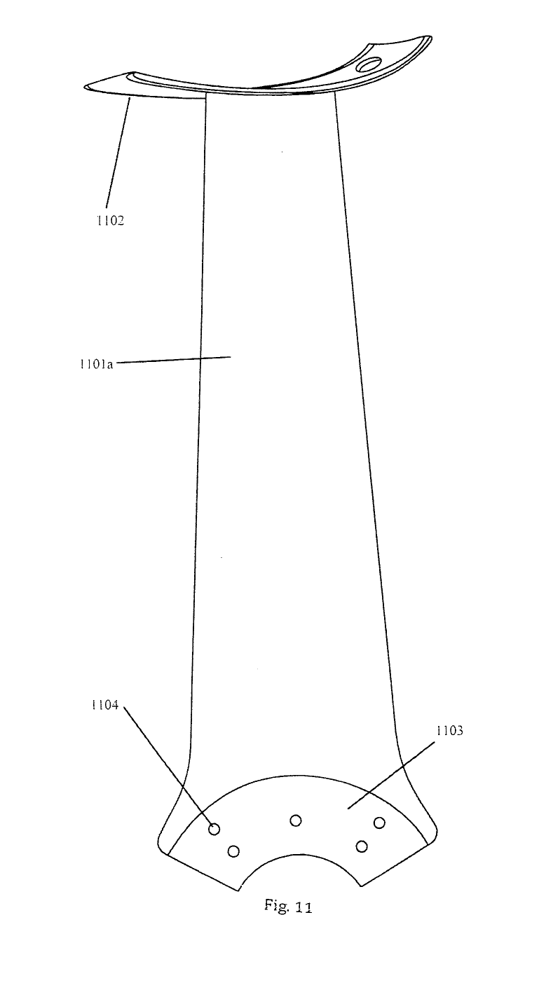

According to FIGS. 5, 6 and 11, the upper or midsection(s) connecting arm 501a, 601a, 1101a shall comprise an attachment piece 502, 602, 1102 the attachment piece 502, 602, 1102 may also comprise other arrangements not shown. The abutment of the connecting arm 503, 603, 1103 may comprise five attachment means 504, 604, 1104.

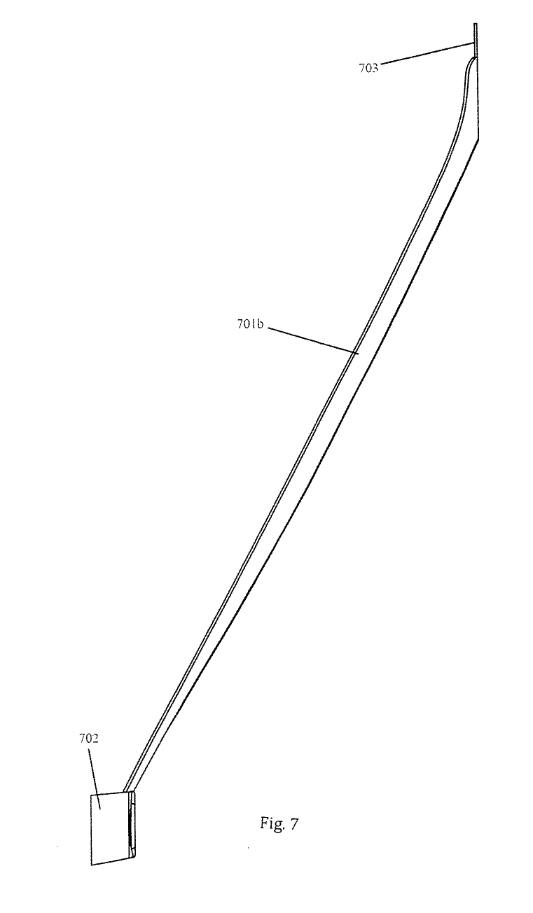

According to FIG. 7 the abutment of the connecting arm 703 shall be arranged at an angle to the connecting arm 701b. The attachment means 702 shall be arranged at an angle to the connecting arm 701b.

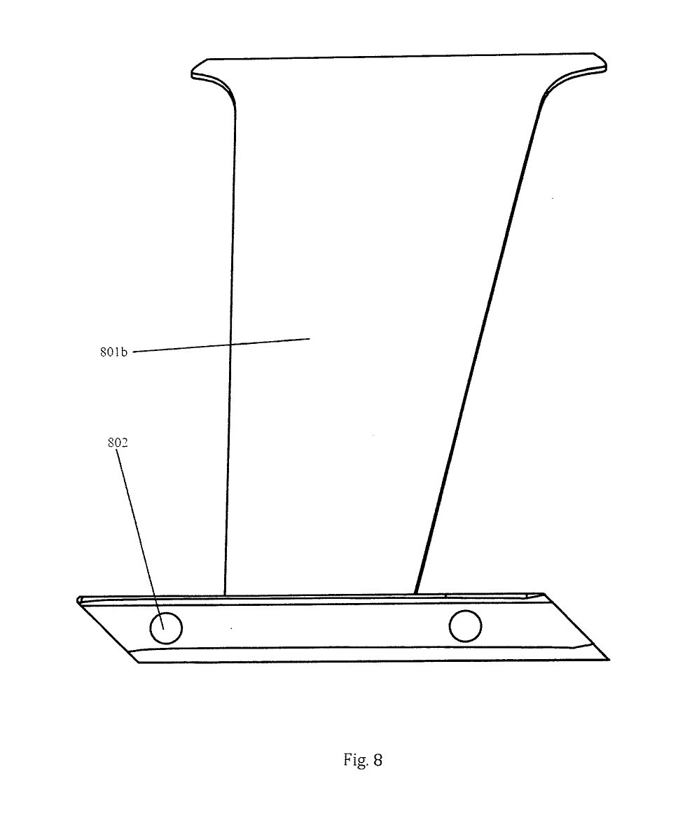

According to FIG. 8 the lower or midsection(s) connecting arm 801b may be arranged with a hoop 802.

The present invention may be structurally modified in various forms by those skilled in the art, while its utilities remained unchanged. Therefore, once the modifications belong to the Claims of the present invention and the equivalent technical field, the present invention may cover all these modifications.

1. A vertical axis wind turbine comprising, at least one connecting arm 101, attached to main blade 206 and an abutment 103 of a connecting arm 101 arranged with an axle hole 105 of wind rotor shaft 207, wherein, a main blade 206 is fixed with an abutment 103 of a connecting arm 101 through a connecting arm to form a vertical axis wind turbine, wherein an upper or midsection(s) connecting arm(s) 201a is attached to a drive shaft barrel 208 of said vertical axis wind turbine via an upper flange at an upper angle of between 45° to 70° and a lower angle of between 100° to 140°, wherein a lower or midsection(s) connecting arm 201b is attached to a drive shaft barrel 208 of said vertical axis wind turbine via a lower flange at a lower angle of between 45° to 70° and an upper angle of between 100° to 140°.

2. The vertical axis wind turbine according to claim 1, wherein a main wind blade comprises at least two blades.

3. The vertical axis wind turbine according to claim 1, wherein said connecting arm(s) form an airfoil.

4. The vertical axis wind turbine according to claim 1, wherein one or more of an airfoil connecting arm(s) comprise at least a two different airfoil thicknesses, the maximum thickness is 15% of a chord length and the minimum thickness is 1% of a chord length.

5. The vertical axis wind turbine according to claim 1 wherein one or more of an airfoil connecting arm(s) comprise an airfoil chord length of between 7 cm and 100 cm.

6. The vertical axis wind turbine according to claim 1, wherein a connecting arm(s) have an opposing airfoil design.

7. The vertical axis wind turbine according to claim 1, wherein one or more of a airfoil connecting arm(s) comprise a concave shape on a trailing edge, next to an abutment of a connecting arm, form an airfoil in a central area and a concave shape next to an attachment piece.

8. The vertical axis wind turbine according to claim 1, wherein a connecting arm and abutment of connecting arm are divided into two or more groups, upper, lower and/or midsection(s), through the two or more groups of a connecting arm(s), a main blade is fixed with two or more groups of abutments of connecting arm(s), upper, lower and midsection(s), at a pre-set angle.

9-10. (canceled)

11. The vertical axis wind turbine according to claim 1, wherein a upper or lower connecting arm is attached via a lower flange to a drive shaft barrel at an angle of 90°.

12. The vertical axis wind turbine according to claim 1, wherein a connecting arm attachment piece is attached to a connecting arm using a hub connecting board, comprising an attachment piece hub connecting segment and a connecting arm wedge-shaped dovetail groove segment.

13. A vertical axis wind turbine according to claim 1, comprising a wind blade with at least two blades, a connecting arm attached to a wind blade and an abutment of a connecting arm comprising a shaft, and an axle hole of wind rotor shaft arranged in the middle of a shaft of a connecting arm, wherein, a wind blade is fixed with a connecting arm shaft through a connecting arm to form a vertical axis wind turbine, and a connecting arm is in the form of an airfoil.

14. The vertical axis wind turbine according to claim 1, wherein a vertical axis compounded wind turbine abutment of a connecting arm comprises high strength glass fiber, plastic, foam or carbon fiber with epoxide resin and/or metal or a mixture thereof.

15. The vertical axis wind turbine according to claim 1, wherein a connecting arm comprises a metal attachment piece extending into the length of a connecting arm and the length of a connecting arm comprises a mixture or anyone of the following fibre glass or carbon fiber with epoxide resin, high strength glass, foam, plastic and/or metal.
